(19) United States
(12) Patent Application Publication
(10) Pub. No.: US 2017/0360104 A1
(43) Pub. Date: Dec. 21, 2017

(54) ELECTRONIC CIGARETTE AND TEMPERATURE CONTROL METHOD THEREOF

(71) Applicant: SHENZHEN FIRST UNION TECHNOLOGY CO., LTD, Shenzhen (CN)

(72) Inventors: Shuyun HU, Shenzhen (CN); Yonghai LI, Shenzhen (CN); Zhongli XU, Shenzhen (CN)

(21) Appl. No.: 15/696,191

(22) Filed: Sep. 6, 2017

(30) Foreign Application Priority Data
Sep. 6, 2016 (CN) 201610805396.6

(51) Int. Cl. A24F 47/00; H05B 1/02

(52) U.S. Cl. CPC A24F 47/008; H05B 1/0297

(57) ABSTRACT

An electronic cigarette and temperature control method thereof are provided. The temperature control method of the electronic cigarette includes: identifying type of tobacco liquid in the electronic cigarette; acquiring preset temperature information corresponding to the type of the tobacco liquid; and controlling the electronic cigarette to work according to the acquired preset temperature information. The method of the present disclosure could adjust the temperature of the electronic cigarette automatically to meet user's need, which could simplify operation and improve the user experience.

### CROSS REFERENCE TO RELATED APPLICATION

This application claims priority to Chinese Patent Application No. 201610805396.6 filed on Sep. 6, 2016, which are hereby incorporated by reference herein as if set forth in its entirety.

### BACKGROUND OF THE INVENTION

### 1. Field of the Invention

The present disclosure generally relates to electronic equipments, and more particular relates to an electronic cigarette and a method for controlling the temperature of an electronic cigarette automatically

### 2. Description of the Prior Art

As a substitute of the traditional cigarette or a tool for quitting smoking, electronic cigarette is commonly used by more and more smokers. Electronic cigarette atomizes tobacco liquid to form aerosol via heating the tobacco liquid by an atomizer.

Different types of tobacco liquid being heated at different temperature may have different atomization effects, which would lead to different user experience. At present, in order to make the atomization of the electronic cigarette meet the needs of user, user needs to adjust the temperature of the electronic cigarette manually. However, adjusting the temperature of the electronic cigarette manually is tedious, thereby leads to poor user experience.

### SUMMARY OF THE INVENTION

Therefore, the primary objective of the present invention is to provide an electronic cigarette and a method for controlling the temperature of an electronic cigarette automatically.

The present invention discloses a temperature control method of electronic cigarette, which comprises identifying type of tobacco liquid in the electronic cigarette; acquiring preset temperature information corresponding to the type of the tobacco liquid; and controlling the electronic cigarette to work according to the acquired preset temperature information.

The present invention further discloses an electronic cigarette, which comprises an atomizer, comprising a heating body with variable temperature; a storage configured to store preset temperature information corresponding to preset multiple types of tobacco liquid; and a controller configured to identify type of tobacco liquid in the electronic cigarette; acquire the preset temperature information corresponding to the type of the tobacco liquid in the electronic cigarette; and control the electronic cigarette to work according to the acquired preset temperature information.

The present invention further discloses an electronic cigarette capable of automatically identify type of tobacco liquid, which comprises an atomizer defining a chamber configured to receive different types of tobacco liquid, wherein each type of tobacco liquid corresponds to a certain temperature curve; the atomizer comprising a heating body configured to heat each type of tobacco liquid according to the certain temperature curve.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart diagram of a temperature control method of electronic cigarette according to an exemplary embodiment of the present disclosure.

FIG. 2 is a flow chart diagram of sub blocks of S11 of the temperature control method of the electronic cigarette according to another exemplary embodiment of the present disclosure.

FIG. 3 is a flow chart diagram of sub block of S112 of the temperature control method of the electronic cigarette according to still another exemplary embodiment of the present disclosure.

FIG. 4 is a flow chart diagram of part of the temperature control method of the electronic cigarette according to another exemplary embodiment of the present disclosure.

FIG. 5 is a flow chart diagram of part of the temperature control method of the electronic cigarette according to still another exemplary embodiment of the present disclosure.

FIG. 6 is a schematic diagram of the electronic cigarette according to an exemplary embodiment of the present disclosure.

FIG. 7 is a schematic diagram of the electronic cigarette according to another exemplary embodiment of the present disclosure.

FIG. 8 is a perspective view of the electronic cigarette according to an exemplary embodiment of the present disclosure.

FIG. 9 is a cross-sectional view of the atomizer of the electronic cigarette according to the exemplary embodiment of the present disclosure.

FIG. 10 is a schematic diagram of a temperature controlling device of the electronic cigarette according to an exemplary embodiment of the present disclosure.

### DETAILED DESCRIPTION

For a thorough understanding of the present disclosure, numerous specific details are set forth in the following description for purposes of illustration but not of limitation, such as particularities of system structures, interfaces, techniques, et cetera. However, it should be appreciated by those of skill in the art that, in absence of these specific details, the present disclosure may also be carried out through other implementations. In other instances, a detailed description of well-known devices, circuits, and methods is omitted, so as to avoid unnecessary details from hindering the description of the disclosure.

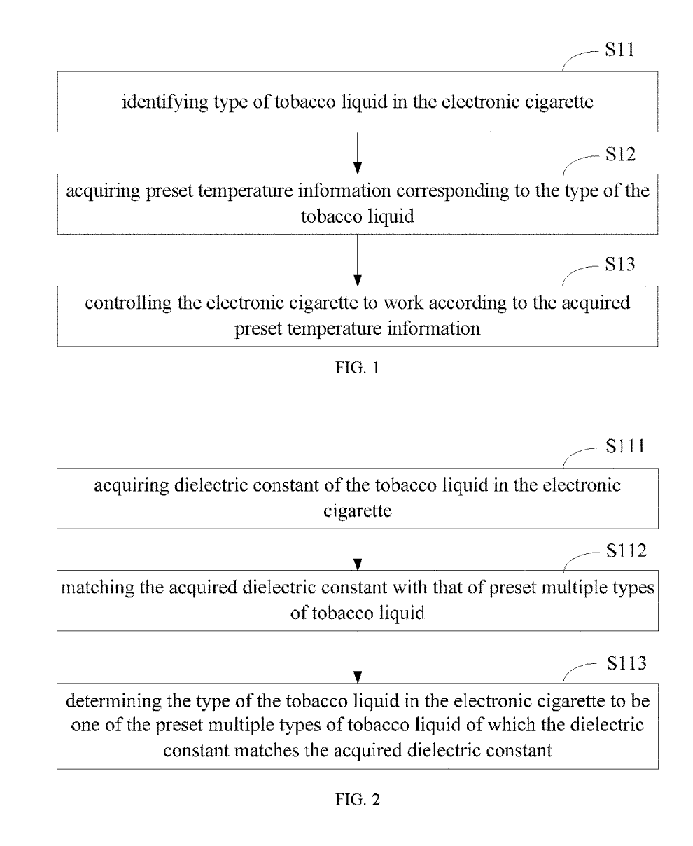

Referring to FIG. 1, a temperature control method of electronic cigarette may include:

S11: Identifying type of tobacco liquid in the electronic cigarette.

For example, when the electronic cigarette is powered on (e.g., a control device or controller of an electronic cigarette is supplied with power), the controller may detect the tobacco liquid in the electronic cigarette so as to identify the type of the tobacco liquid.

Particularly, the type of the tobacco liquid may be identified via a dielectric constant of the tobacco liquid. As shown in FIG. 2, in another embodiment, the block S11 may include:

S111: Acquiring dielectric constant of the tobacco liquid in the electronic cigarette.

S112: Matching the acquired dielectric constant with that of preset multiple types of tobacco liquid.

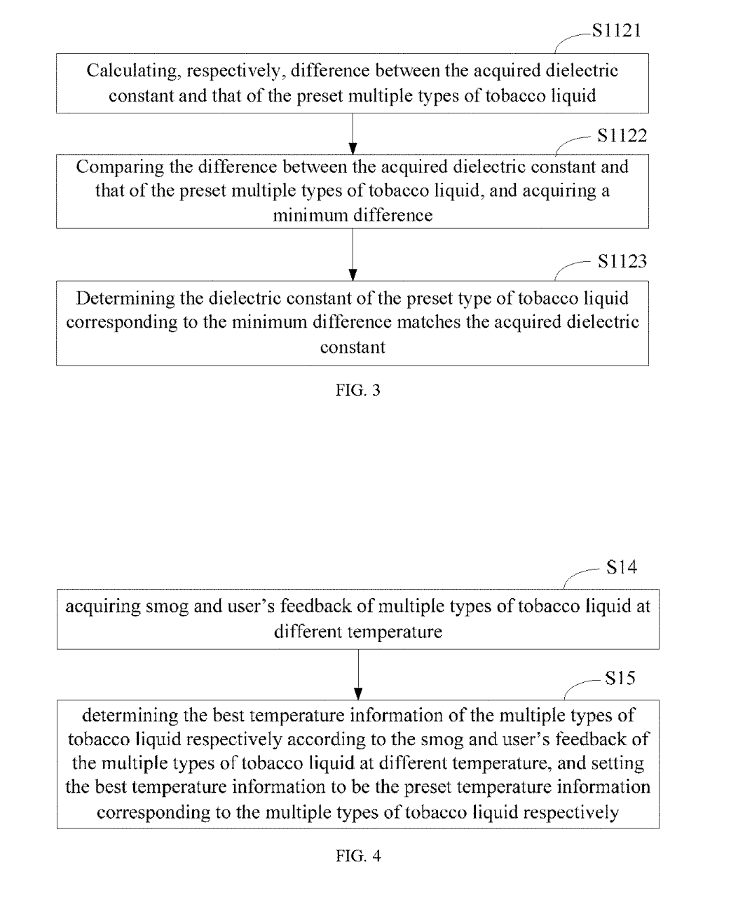

Referring to FIG. 3, in still another embodiment, the block S112 may further include:

S1121: Calculating, respectively, difference between the acquired dielectric constant and that of the preset multiple types of tobacco liquid.

S1122: Comparing the difference between the acquired dielectric constant and that of the preset multiple types of tobacco liquid, and acquiring a minimum difference.

S1123: Determining the dielectric constant of a preset type of tobacco liquid corresponding to the minimum difference matches the acquired dielectric constant.

S113: Determining the tobacco liquid in the electronic cigarette to be one of the preset multiple types of tobacco liquid of which the dielectric constant matches the acquired dielectric constant.

Because the dielectric constants of different types of tobacco liquid are different from each other, the type of the tobacco liquid in the electronic cigarette could be identified via the dielectric constant of the tobacco liquid. The different types of tobacco liquid may be tobacco liquid that is same in component but different in composition. In this embodiment, dielectric constants of the preset multiple types of tobacco liquid may be pre-stored in a storage of the electronic cigarette. The electronic cigarette may obtain the dielectric constant of the tobacco liquid in the electronic cigarette via a dielectric constant sensor thereof, and compare the acquired dielectric constant with the dielectric constants of the preset multiple types of tobacco liquid one by one, so as to acquire one dielectric constant that matches the acquired dielectric constant best from the dielectric constants of the preset multiple types of tobacco liquid. The dielectric constant that matches the acquired dielectric constant may be the one that is closest to the acquired dielectric constant. It can be understood that, in other embodiments, the dielectric constant that matches the acquired dielectric constant best may also be determined according to other judgment conditions, which is not limited in the present disclosure.

When the dielectric constant that matches the acquired dielectric constant best is determined, a type of tobacco liquid of the preset multiple types of tobacco liquid that is corresponding to the dielectric constant could be considered to be the type of the tobacco liquid in the electronic cigarette.

It can be understood that, in other embodiments, the type of the tobacco liquid in the electronic cigarette may not be identified according to the dielectric constant, but the component of the tobacco liquid and the composition of the component, which is not limited in the present disclosure.

S12: Acquiring preset temperature information corresponding to the type of the tobacco liquid.

A variety of preset temperature information corresponding to the preset multiple types of tobacco liquid respectively may be pre-stored in the electronic cigarette. After the type of the tobacco liquid in the electronic cigarette is identified, the controller may find out the preset temperature information corresponding to the type of the tobacco liquid in the electronic cigarette from the variety of preset temperature information pre-stored in the electronic cigarette.

Particularly, the preset temperature information may include a preset time-dependent temperature curve, which may indicate the temperature at which the electronic cigarette should be set at different time after the electronic cigarette is lit. Optionally, the preset temperature information may also be other forms, such as, a fixed temperature that is time-independent, or a set of ordered pairs, each of which may include a time note and a temperature value corresponding to the time note.

S13: Controlling the electronic cigarette to work according to the acquired preset temperature information.

The preset temperature information is the temperature that the electronic cigarette, specifically, the atomizer of the electronic cigarette is heated to at relevant time. For instance, after getting the time-dependent temperature curve, the controller could control the atomizer of the electronic cigarette to work according to the time-dependent temperature curve. In some embodiments, the atomizer may contain a heating body, when the preset temperature information is the time-dependent temperature curve, the controller may control the heating temperature of the heating body according to the time-dependent temperature curve; when the preset temperature information is the fixed temperature, the controller may control the heating temperature of the heating body according to the fixed temperature; and when the preset temperature information is the set of ordered pairs, the controller may control the heating temperature of the heating body according to the set of ordered pairs.

For example, information contains a first type of tobacco liquid, a first dielectric constant corresponding to the first type of tobacco liquid, a first time-dependent temperature curve corresponding to the first type of tobacco liquid, a second type of tobacco liquid, a second dielectric constant corresponding to the second type of tobacco liquid, a second time-dependent temperature curve corresponding to the second type of tobacco liquid, a third type of tobacco liquid, a third dielectric constant corresponding to the third type of tobacco liquid and a third time-dependent temperature curve corresponding to the third type of tobacco liquid is pre-stored in the electronic cigarette. When the electronic cigarette is electrically charged, the controller of the electronic cigarette may detect the dielectric constant of the tobacco liquid in the atomizer of the electronic cigarette, compare the dielectric constant of the tobacco liquid in the atomizer of the electronic cigarette to the first dielectric constant, the second dielectric constant and the third dielectric constant pre-stored in the electronic cigarette, if the first dielectric constant is closest to the dielectric constant of the tobacco liquid in the atomizer of the electronic cigarette, determine the first dielectric constant matches the dielectric constant of the tobacco liquid in the atomizer of the electronic cigarette, and further determine that the type of the tobacco liquid in the electronic cigarette to be the first type of tobacco liquid, thereby obtain the first time-dependent temperature curve, and then control the heating body of the atomizer to work according to the first time-dependent temperature curve.

In the present disclosure, the electronic cigarette could identify the type of the tobacco liquid therein, and determine the preset temperature information needed according to the type of the tobacco liquid, so as to work according to the preset temperature information, in this way, the electronic cigarette could adjust its temperature during working intelligently, without manual adjustment, which could simplify operation and improve the user experience.

Referring to FIG. 4, in this embodiment, before the block S11, the method of the present disclosure may further include:

S14: Acquiring aerosol and user's feedback of multiple types of tobacco liquid at different temperature.

S15: Determining the best temperature information of the multiple types of tobacco liquid respectively according to the aerosol and user's feedback of the multiple types of tobacco liquid at different temperature, and setting the best temperature information to be the preset temperature information corresponding to the multiple types of tobacco liquid respectively.

Taste and aerosol generated by different types of tobacco liquid being atomized at different temperature may be distinct. Information about aerosol and user's feedback, such as the flavor and the like, of the different types of tobacco liquid being atomized at different temperature could be pre-detected, and the best temperature information of each type of tobacco liquid could be determined according to a selection strategy, and the best temperature information could be set to be the preset temperature information corresponding to each type of tobacco liquid. Specifically, the selection strategy may be selecting the temperature of the atomizer that when the taste is better or selecting the temperature of the atomizer that when both of the taste and the aerosol are better, and so forth.

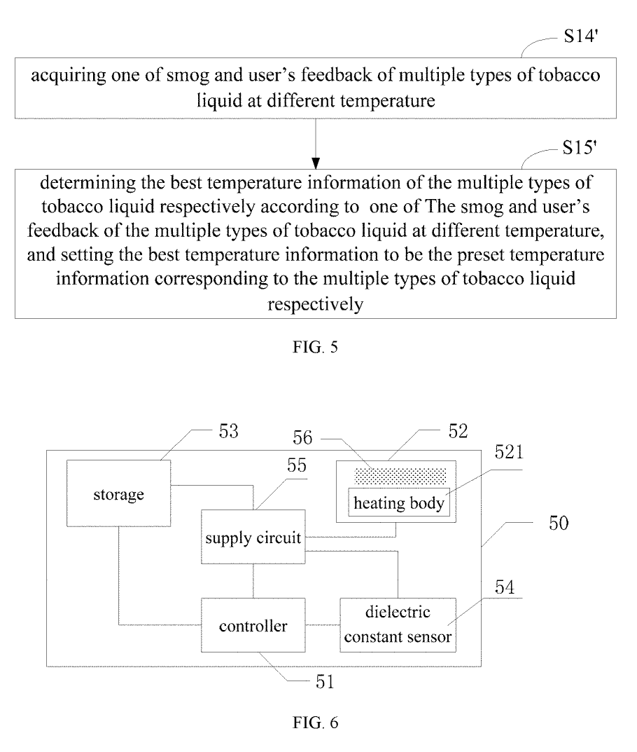

As shown in FIG. 5, in this embodiment, before the block S11, the method of the present disclosure may further include:

S14′: Acquiring one of aerosol and user's feedback of multiple types of tobacco liquid at different temperature.

S15′: Determining the best temperature information of the multiple types of tobacco liquid respectively according to one of the aerosol and user's feedback of the multiple types of tobacco liquid at different temperature, and setting the best temperature information to be the preset temperature information corresponding to the multiple types of tobacco liquid respectively.

It can be understood that, in other embodiments, the preset temperature information of each type of tobacco liquid may also be determined by a tobacco tasting engineer who tastes the tobacco liquid atomized at different temperature, in this way, the blocks S14-S15 or S14′-S15′ need not to be executed.

Referring to FIG. 6, in this embodiment, an electronic cigarette 50 may include a controller 51, an atomizer 52 and a storage 53. In particularly, the atomizer 52 may include a heating body 521 with variable temperature. The atomizer 52 may be configured to heat tobacco liquid 56 therein through the heating body 521, so as to atomize the tobacco liquid 56 to form aerosol. The storage 53 may be configured to store a variety of preset temperature information corresponding to preset multiple types of tobacco liquid and computer instruction. The controller 51 may be configured to execute the computer instruction to identify type of tobacco liquid 56 in the electronic cigarette 50; acquire the preset temperature information corresponding to the type of the tobacco liquid 56 in the electronic cigarette 50; and control the heating body 521 of the atomizer 52 to work according to the acquired preset temperature information.

Optionally, the electronic cigarette 50 may include a dielectric constant sensor 54 configured to acquire dielectric constant of the tobacco liquid 56 in the electronic cigarette, and transmit the dielectric constant of the tobacco liquid 56 to the controller 51.

The storage 53 may further be configured to store varieties of dielectric constants corresponding the preset multiple types of tobacco liquid.

The controller 51 may further be configured to invoke the dielectric constants of the preset multiple types of tobacco liquid, match the acquired dielectric constant with that of the preset multiple types of tobacco liquid; and determine the type of the tobacco liquid 56 in the electronic cigarette to be one of the preset multiple types of tobacco liquid of which the dielectric constant matches the acquired dielectric constant.

The controller 51 may further configured to calculate, respectively, difference between the acquired dielectric constant and that of the preset multiple types of tobacco liquid; compare the difference between the acquired dielectric constant and that of the preset multiple types of tobacco liquid, and acquire a minimum difference; and determine the dielectric constant of a preset type of tobacco liquid corresponding to the minimum difference matches the acquired dielectric constant.

In the specific application, the dielectric constant sensor 54 may be controlled by the controller 51, for example, when the controller 51 inputs a detecting instruction, the dielectric constant sensor 54 may detect the dielectric constant of the tobacco liquid 56 in the atomizer 52, and may output the dielectric constant to the controller 51.

It can be understood that, in other embodiments, the type of tobacco liquid in the electronic cigarette may be not recognized according the dielectric constant, in this case, the electronic cigarette may not contain the dielectric constant sensor.

Optionally, the preset temperature information may be a time-dependent temperature curve, a fixed temperature or a set of ordered pairs, each of which may include a time note and a temperature value corresponding to the time note.

Optionally, the controller 51 may further configured to: acquire aerosol and user's feedback of multiple types of tobacco liquid heated at different temperature, and determine the best temperature information of the multiple types of tobacco liquid respectively according to the aerosol and user's feedback, and set the best temperature information to be the preset temperature information corresponding to the multiple types of tobacco liquid respectively.

Optionally, in another embodiment, the controller 51 may further configured to: acquire aerosol or user's feedback of multiple types of tobacco liquid heated at different temperature, and determine the best temperature information of the multiple types of tobacco liquid respectively according to one of the aerosol or user's feedback, and set the best temperature information to be the preset temperature information corresponding to the multiple types of tobacco liquid respectively.

In other embodiments, the electronic cigarette 50 may further include a supply circuit 55 configured to supply power to the controller 51, the storage 53 and the heating body 521 of the atomizer 52. The controller 51 may perform the functions above when being supplied power by the supply circuit 55.

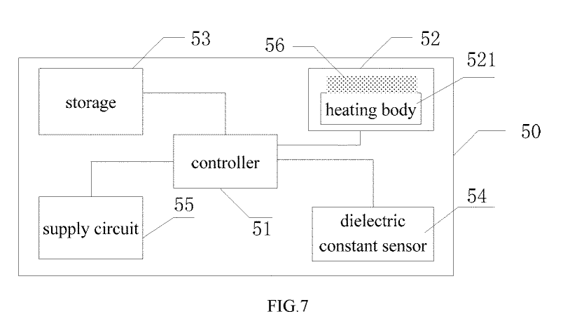

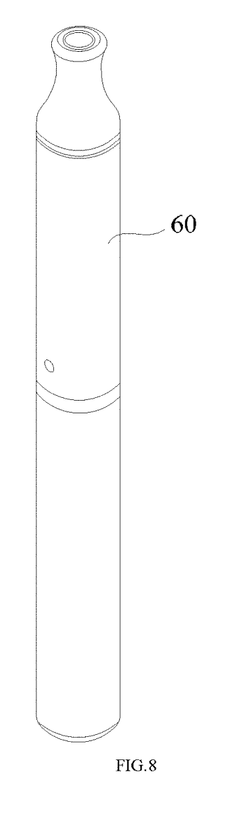

As shown in FIG. 6, in one embodiment, the supply circuit 55 may supply power to the storage 53 and the atomizer 52 directly. As shown in FIG. 7, in the other embodiment, the supply circuit 55 may supply power to the storage 53 and the atomizer 52 through the controller 51.

Specifically, the supply circuit 55 could supply power to the controller 51, the storage 53 and the heating body 521 of the atomizer 52 through a self-powered mode or an external-powered mode, for example, in one embodiment, the supply circuit 55 may include a battery, so as to achieve the self-powered mode; in another embodiment, the supply circuit 55 may include an external power supply interface through which the electronic cigarette accesses to external current/voltage to realize the external-powered mode.

The controller 51 of this embodiment may further configured to perform the temperature control method of electronic cigarette of the embodiments mentioned above.

Referring to FIGS. 8-9, in this embodiment, an electronic cigarette 60 capable of automatically identify type of tobacco liquid therein may include an atomizer 61 defining a chamber 62 configured to receive different types of tobacco liquid, wherein each type of tobacco liquid corresponds to a certain temperature curve. The atomizer 61 may include a heating body 63 configured to heat each type of tobacco liquid according to the certain temperature curve. Specifically, each type of tobacco liquid may include a certain dielectric constant corresponding to the certain temperature curve. In this embodiment, the electronic cigarette 60 may include a sensor 64 configured to acquire dielectric constant of the tobacco liquid.

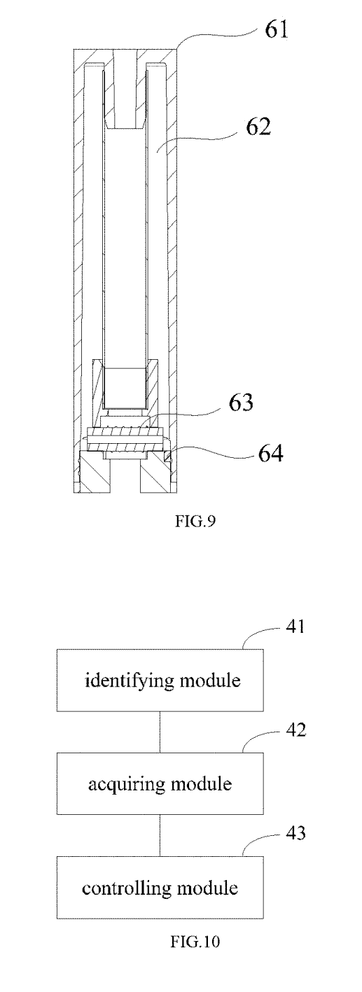

Referring to FIG. 10, in this embodiment, a temperature controlling device may include an identifying module 41, acquiring module 42 and a controlling module 43.

The identifying module 41 may be configured to identify type of tobacco liquid in the electronic cigarette.

The acquiring module 42 maybe configured to acquire the preset temperature information corresponding to the type of the tobacco liquid in the electronic cigarette.

The controlling module 43 may be configured to control the electronic cigarette to work according to the acquired preset temperature information.

Optionally, the identifying module 41 may further configured to acquire dielectric constant of the tobacco liquid in the electronic cigarette; match the acquired dielectric constant with that of preset multiple types of tobacco liquid; and determine the type of the tobacco liquid in the electronic cigarette to be one of the preset multiple types of tobacco liquid of which the dielectric constant matches the acquired dielectric constant.

Optionally, in one embodiment, the preset temperature information may include a preset time-dependent temperature curve, the controlling module 43 may be configured to control atomizer of the electronic cigarette to work according to the preset time-dependent temperature curve. In another embodiment, the preset temperature information may include a fixed temperature, the controlling module 43 may be configured to control atomizer of the electronic cigarette to work at the fixed temperature. In still another embodiment, the preset temperature information may include a set of ordered pairs, each of which may include a time note and a temperature value corresponding to the time note, the controlling module 43 may be configured to control atomizer of the electronic cigarette to work according to the set of ordered pairs.

Optionally, the temperature controlling device may further include a presetting module, in one embodiment, the presetting module may be configured to acquire aerosol and user's feedback of multiple types of tobacco liquid at different temperature; determine the best temperature information of the multiple types of tobacco liquid respectively according to the aerosol and user's feedback of the multiple types of tobacco liquid at different temperature, and set the best temperature information to be the preset temperature information corresponding to the multiple types of tobacco liquid respectively. In the other embodiment, the presetting module maybe configured to acquire one of aerosol and user's feedback of multiple types of tobacco liquid at different temperature; determine the best temperature information of the multiple types of tobacco liquid respectively according to one of the aerosol and user's feedback of the multiple types of tobacco liquid at different temperature, and set the best temperature information to be the preset temperature information corresponding to the multiple types of tobacco liquid respectively.

In one embodiment, the temperature controlling device may be the controller of the electronic cigarette mentioned above, modules of the temperature controlling device above may configured to execute the corresponding blocks of the mentioned temperature control method, specific implementation process is identical to the temperature control method above, the details are not recited herein.

In the present disclosure, the electronic cigarette could identify the type of the tobacco liquid therein, and determine the preset temperature information needed according to the type of the tobacco liquid, so as to work according to the preset temperature information, in this way, the electronic cigarette could adjust its temperature during working intelligently, without manual adjustment, which could simplify operation and improve the user experience.

The above description depicts merely some exemplary embodiments of the disclosure, but is meant to limit the scope of the disclosure. Any equivalent structure or flow transformations made to the disclosure, or any direct or indirect applications of the disclosure on other related fields, shall all be covered within the protection of the disclosure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A temperature control method of electronic cigarette, comprising:
identifying type of tobacco liquid in the electronic cigarette;
acquiring preset temperature information corresponding to the type of the tobacco liquid; and
controlling the electronic cigarette to work according to the acquired preset temperature information.

2. The temperature control method of claim 1, wherein the identifying type of tobacco liquid in the electronic cigarette further comprises:
acquiring dielectric constant of the tobacco liquid in the electronic cigarette;
matching the acquired dielectric constant with that of preset multiple types of tobacco liquid; and
determining the type of the tobacco liquid in the electronic cigarette to be one of the preset multiple types of tobacco liquid of which the dielectric constant matches the acquired dielectric constant.

3. The temperature control method of claim 2, wherein the matching the acquired dielectric constant with that of preset multiple types of tobacco liquid further comprises:
calculating, respectively, difference between the acquired dielectric constant and that of the preset multiple types of tobacco liquid;
comparing the difference between the acquired dielectric constant and that of the preset multiple types of tobacco liquid, and acquiring a minimum difference; and
determining the dielectric constant of a preset type of tobacco liquid corresponding to the minimum difference matches the acquired dielectric constant.

4. The temperature control method of claim 3, before the identifying type of tobacco liquid in the electronic cigarette, further comprising:
acquiring aerosol and user's feedback of multiple types of tobacco liquid at different temperature;
determining the best temperature information of the multiple types of tobacco liquid respectively according to the aerosol and user's feedback of the multiple types of tobacco liquid at different temperature, and setting the best temperature information to be the preset temperature information corresponding to the multiple types of tobacco liquid respectively.

5. The temperature control method of claim 3, before the identifying type of tobacco liquid in the electronic cigarette, further comprising:
acquiring one of aerosol and user's feedback of multiple types of tobacco liquid at different temperature;
determining the best temperature information of the multiple types of tobacco liquid respectively according to one of the aerosol and user's feedback of the multiple types of tobacco liquid at different temperature, and setting the best temperature information to be the preset temperature information corresponding to the multiple types of tobacco liquid respectively.

6. The temperature control method of claim 1, wherein the preset temperature information comprises a preset time-dependent temperature curve;
the controlling the electronic cigarette to work according to the acquired preset temperature information comprises:
controlling atomizer of the electronic cigarette to work according to the preset time-dependent temperature curve.

7. The temperature control method of claim 1, wherein the preset temperature information comprises a fixed temperature;
the controlling the electronic cigarette to work according to the acquired preset temperature information comprises:
controlling atomizer of the electronic cigarette to work at the fixed temperature.

8. The temperature control method of claim 1, wherein the preset temperature information comprises a set of ordered pairs, wherein each ordered pair comprises a time note and a temperature value corresponding to the time note;
the controlling the electronic cigarette to work according to the acquired preset temperature information comprises:
controlling atomizer of the electronic cigarette to work according to the set of ordered pairs.

9. An electronic cigarette, comprising:
an atomizer, comprising a heating body with variable temperature;
a storage configured to store preset temperature information corresponding to preset multiple types of tobacco liquid; and
a controller configured to identify type of tobacco liquid in the electronic cigarette; acquire the preset temperature information corresponding to the type of the tobacco liquid in the electronic cigarette; and control the electronic cigarette to work according to the acquired preset temperature information.

10. The electronic cigarette of claim 9, further comprising a dielectric constant sensor configured to acquire dielectric constant of the tobacco liquid in the electronic cigarette, and transmit the dielectric constant of the tobacco liquid to the controller;
the controller is further configured to match the acquired dielectric constant with that of the preset multiple types of tobacco liquid; and determine the type of the tobacco liquid in the electronic cigarette to be one of the preset multiple types of tobacco liquid of which the dielectric constant matches the acquired dielectric constant.

11. The electronic cigarette of claim 10, wherein the controller is further configured to calculate, respectively, difference between the acquired dielectric constant and that of the preset multiple types of tobacco liquid; compare the difference between the acquired dielectric constant and that of the preset multiple types of tobacco liquid, and acquire a minimum difference; and determine the dielectric constant of a preset type of tobacco liquid corresponding to the minimum difference matches the acquired dielectric constant.

12. The electronic cigarette of claim 11, wherein the controller is further configured to acquire aerosol and user's feedback of multiple types of tobacco liquid at different temperature; determine the best temperature information of the multiple types of tobacco liquid respectively according to the aerosol and user's feedback of the multiple types of tobacco liquid at different temperature, and set the best temperature information to be the preset temperature information corresponding to the multiple types of tobacco liquid respectively.

13. The electronic cigarette of claim 11, wherein the controller is further configured to acquire one of aerosol and user's feedback of multiple types of tobacco liquid at different temperature; determine the best temperature information of the multiple types of tobacco liquid respectively according to one of the aerosol and user's feedback of the multiple types of tobacco liquid at different temperature, and set the best temperature information to be the preset temperature information corresponding to the multiple types of tobacco liquid respectively.

14. The electronic cigarette of claim 9, wherein the preset temperature information comprises a preset time-dependent temperature curve;
the controller is further configured to control atomizer of the electronic cigarette to work according to the preset time-dependent temperature curve.

15. The electronic cigarette of claim 9, wherein the preset temperature information comprises a fixed temperature;
the controller is further configured to control atomizer of the electronic cigarette to work at the fixed temperature.

16. The electronic cigarette of claim 9, wherein the preset temperature information comprises a set of ordered pairs, wherein each ordered pair comprises a time note and a temperature value corresponding to the time note;
the controller is further configured to control atomizer of the electronic cigarette to work according to the set of ordered pairs.

17. The electronic cigarette of claim 9, further comprising a supply circuit configured to supply power to the controller, the storage and the atomizer.

18. An electronic cigarette capable of automatically identify type of tobacco liquid, comprising:
an atomizer defining a chamber configured to receive different types of tobacco liquid, wherein each type of tobacco liquid corresponds to a certain temperature curve; the atomizer comprising a heating body configured to heat each type of tobacco liquid according to the certain temperature curve.

19. The electronic cigarette of claim 18, wherein each type of tobacco liquid comprises a certain dielectric constant corresponding to the certain temperature curve.

20. The electronic cigarette of claim 18, further comprising a sensor configured to acquire dielectric constant of the tobacco liquid, each type of tobacco liquid comprising a certain dielectric constant corresponding to the certain temperature curve.
